(19) United States
(12) Patent Application Publication
(10) Pub. No.: US 2022/0401296 A1
(43) Pub. Date: Dec. 22, 2022

(54) MASSAGE BEAUTY INSTRUMENT

(71) Applicant: Shenzhen Yumi Info. Co., Ltd, Shenzhen (CN)

(72) Inventors: Xuelian ZHANG, Shenzhen (CN); Caixia Li, Shenzhen (CN)

(21) Appl. No.: 17/714,165

(22) Filed: Apr. 6, 2022

(30) Foreign Application Priority Data
Jun. 17, 2021 (CN) 202121357628.9

(51) Int. Cl. A61H 23/02

(52) U.S. Cl. CPC A61H 23/0263; A61H 2201/0153; A61H 2023/0281; A61H 2205/022; A61H 2201/0157

(57) ABSTRACT

Disclosed is a massage beauty instrument, which includes a main body. The main body includes a host and a beauty massage head connected to the host. The beauty massage head is provided with a vibration portion therein. The vibration portion includes a driving motor fixed in the beauty massage head, a first eccentric wheel and a second eccentric wheel connected in series to both ends of an output shaft of the driving motor, respectively.

### CROSS REFERENCE TO RELATED APPLICATION

The present disclosure claims priority to Chinese Patent Application No. 202121357628.9, filed Jun. 17, 2021, which is hereby incorporated by reference herein as if set forth in its entirety.

### BACKGROUND

### 1. Technical Field

The present disclosure relates to the field of facial massage beauty instruments, and particular to a massage beauty instrument.

### 2. Description of Related Art

With the great abundance of material life, people pay more and more attention to their skin care especially women. When people take care of their skin, cosmetics such as lotion or moisturizing water are usually smeared on the face, and then the face is massaged by holding a massager or by professional people, so that the cosmetics are absorbed by the face, thereby achieving the effect of skin care. However, the process of skin care is troublesome, and it is expensive and takes a lot of time to attend the beauty shop for skin care. Therefore, portable household massage beauty instruments came into being, and the principle thereof is that the skin of a human body is beautified by using methods such as physics, electronic technology, optics and the like, so that beauty lovers can conveniently carry out personal care anytime and anywhere.

In order for the face to better absorb nutritional ingredients of a skin care product, the skin care product is poured to the palm of the hand of an individual during massage, and then the face is flapped and massaged after the hands rub the skin care product to be warm, so that the face absorption is promoted. In order to achieve the same effect, the massage beauty instrument also has a vibration function, a massage disk is attached to the face after being heated, and the massage disk continuously vibrates to increase the surface activity of the skin and open pores, and to introduce the nutrition of the skin care product into the face during the continuous vibration process. However, the massage beauty instrument on the market at present also adopts a vibration arrangement. For example, chinese patent No. 2016210505825 discloses a massage device with a vibration function, in which a vibration component is provided, the vibration component includes a motor and an eccentric wheel. However, an intensity of vibration frequency is not high enough, so the vibration effect is not good, and the function of introducing the nutrient solution cannot be realized well.

In addition, in order to enhance the intensity of vibration frequency, a conventional massage beauty instrument in the market is also provided with two vibration components, namely each of the vibration components includes a motor and an eccentric wheel, so that a large mounting and assembly space is required, and the development of the volume of the massage beauty instrument towards miniaturization is not facilitated.

### BRIEF DESCRIPTION OF THE DRAWINGS

In order to more clearly illustrate the technical solutions in this embodiment disclosure, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a partial schematic view of a massage beauty instrument according to the present disclosure.

FIG. 2 is a partial schematic view of a massage beauty instrument according to the present disclosure.

FIG. 3 is a schematic view of a massage beauty instrument according to the present disclosure.

### DETAILED DESCRIPTION

In order to make the objectives, technical solutions, and advantages of the present disclosure clearer, the present disclosure will be further described in detail below with reference to the drawings and embodiments. It should be understood that, the embodiments described herein are only for explaining the present disclosure and are not intended to limit the present disclosure.

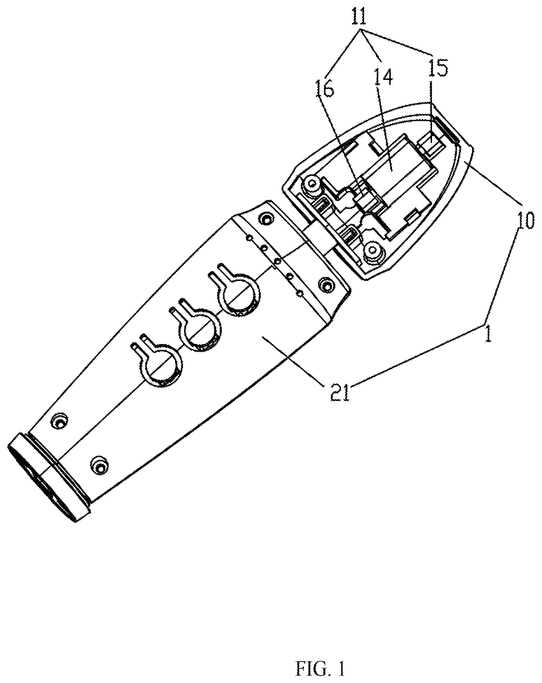

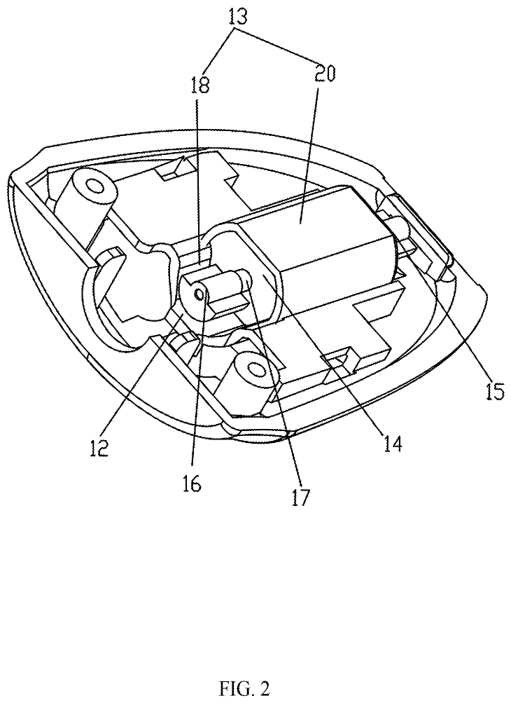

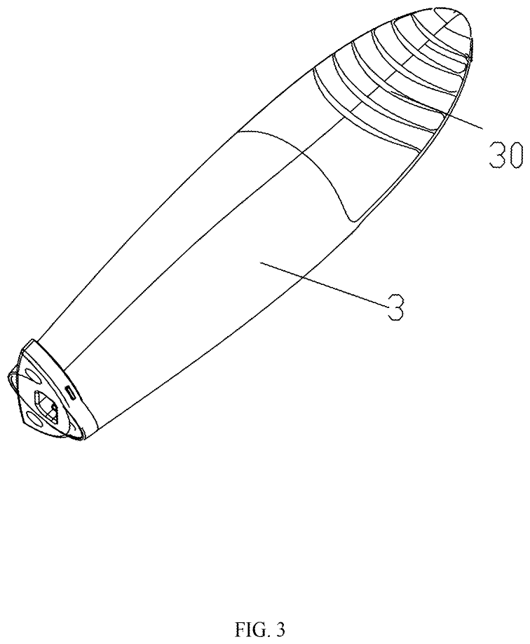

Referring to FIG. 1 to FIG. 3, an embodiment of the present disclosure provides a massage beauty instrument, including a main body 1. The main body 1 includes a host 21 and a beauty massage head 10 connected to the host 21. The beauty massage head 10 is provided with a vibration portion 11 therein. The vibration portion 11 includes a driving motor 14 fixed in the beauty massage head 10, a first eccentric wheel 15 and a second eccentric wheel 16 connected in series to both ends of an output shaft 17 of the driving motor 14, respectively.

In this embodiment, the first eccentric wheel 15 and the second eccentric wheel 16 are connected in series to both ends of the output shaft 17 of the driving motor 14, respectively, so that the output shaft 17 of the driving motor 14 can drive both the first eccentric wheel 15 and the second eccentric wheel 16 to rotate together, and when the first eccentric wheel 15 and the second eccentric wheel 16 rotate, the beauty massage head 10 can vibrate. Compared with a massage beauty instrument in related art, which is only provided with one eccentric wheel, the massage beauty instrument according to the present disclosure has a higher intensity of vibration frequency, and thus a better vibration effect. In addition, compared with the massage beauty instrument in the related art, two motors need to be mounted to respectively drive an eccentric wheel, so as to obtain the vibration effect of the present disclosure, but there is a problem that the massage beauty instrument in the related art requires a large mounting space for two motors and two eccentric wheels.

In this embodiment, in the massage beauty instrument according to the present disclosure, the first eccentric wheel 15 and the second eccentric wheel 16 are connected in series at the both ends of the output shaft 17 of the driving motor 14, respectively, so that the intensity of vibration frequency is increased, the vibration effect is good, and the function of introducing the nutrient solution can be better realized. In addition, it does not need to occupy a large mounting space, and the volume of the massage beauty instrument can be miniaturized.

Further, the output shaft 17 extends through both ends of the driving motor 14, and the driving motor 14 drives the output shaft 17 to rotate.

Further, the beauty massage head 10 is provided with a rotating cavity 12 allowing the first eccentric wheel 15 and the second eccentric wheel 16 to rotate. The rotating cavity 12 provides a rotation space for the first eccentric wheel 15 and the second eccentric wheel 16.

Further, the beauty massage head 10 is provided with a fixing portion 13, and the fixing portion 13 is configured to fix the driving motor 14.

Further, the fixing portion 13 includes a fixing position 18 configured to mount the driving motor 14, and a blocking portion 20 configured to prevent the driving motor 14 from being separated from the fixing position 18.

In this embodiment, the cooperation of the fixing position 18 and the blocking portion 20 enables the driving motor 14 to be fixed in the fixing portion 13.

Further, a housing 3 is further included, and the main body 1 is packaged in the housing 3.

Further, the housing 3 is provided with a massage portion 30 on a surface thereof.

In this embodiment, the massage portion 30 facilitates the introduction of the nutrient solution by the massage, and the massage portion 30 includes, but is not limited to, massage protrusions, massage bristles, etc.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A massage beauty instrument, comprising a main body, the main body comprising a host and a beauty massage head connected to the host, the beauty massage head being provided with a vibration portion therein, the vibration portion comprising a driving motor fixed in the beauty massage head, a first eccentric wheel and a second eccentric wheel connected in series to both ends of an output shaft of the driving motor, respectively.

2. The massage beauty instrument of claim 1, wherein the output shaft extends through both ends of the driving motor, and the driving motor drives the output shaft to rotate.

3. The massage beauty instrument of claim 1, wherein the beauty massage head is provided with a rotating cavity allowing the first eccentric wheel and the second eccentric wheel to rotate.

4. The massage beauty instrument of claim 1, wherein the beauty massage head is provided with a fixing portion, and the fixing portion is configured to fix the driving motor.

5. The massage beauty instrument of claim 4, wherein the fixing portion comprises a fixing position configured to mount the driving motor, and a blocking portion configured to prevent the driving motor from being separated from the fixing position.

6. The massage beauty instrument of claim 1, further comprising a housing, the main body being packaged in the housing.

7. The massage beauty instrument of claim 6, wherein the housing is provided with a massage portion on a surface thereof.
